(19) United States
(12) Patent Application Publication
(10) Pub. No.: US 2024/0223994 A1
(43) Pub. Date: Jul. 4, 2024

(54) APPARATUS FOR CONTROLLING OUTPUT OF MEDIA CONTENT, SYSTEM, AND METHOD FOR CONTROLLING OUTPUT OF MEDIA CONTENT

(71) Applicant: Intel Corporation, Santa Clara, CA (US)

(72) Inventors: Balvinder SINGH, Bhilai (IN); Sheetal BHASIN, Bangalore (IN); Gila KAMHI, Zichron Yaakov (IL); Denis KLIMOV, Beer Sheba (IL)

(21) Appl. No.: 18/147,726

(22) Filed: Dec. 29, 2022

(51) Int. Cl. H04W 4/02; H04N 21/436; H04W 4/80; H04W 76/10

(52) U.S. Cl. CPC H04W 4/023; H04N 21/436; H04W 4/80; H04W 76/10

(57) ABSTRACT

An apparatus for controlling output of media content is provided. The apparatus comprises interface circuitry configured to receive input data at least indicating a current state of a radio connection of a wearable device and a respective proximity of the wearable device to one or more playback-capable devices, the radio connection being used to transfer the media content. The apparatus further comprises processing circuitry configured to determine, based on the input data, one or more of the wearable device and the one or more playback-capable devices for output of the media content, and generate, based on the determination, output data for controlling the output of the media content.

### BACKGROUND

A wearable device may be coupled to another device by a radio connection. Further, the wearable device may at least playback media content transferred via the wireless connection. However, radio connection and/or playback impairments may occur when a user of the wearable device moves from one location to another.

Hence, there may be a demand for improved controlling output of media content.

### BRIEF DESCRIPTION OF THE FIGURES

Some examples of apparatuses and/or methods will be described in the following by way of example only, and with reference to the accompanying figures, in which

FIG. 1 illustrates an exemplary apparatus for controlling output of media content in an exemplary application scenario;

FIG. 2 illustrates another exemplary apparatus for controlling output of media content in an exemplary application scenario;

FIG. 3 illustrates another exemplary apparatus for controlling output of media content in an exemplary application scenario;

FIG. 4 illustrates another exemplary apparatus for controlling output of media content in an exemplary application scenario;

FIG. 5 illustrates another exemplary apparatus for controlling output of media content in an exemplary application scenario;

FIG. 6 illustrates another exemplary apparatus for controlling output of media content in an exemplary application scenario; and

FIG. 7 illustrates in a flowchart an exemplary method for controlling output of media content.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

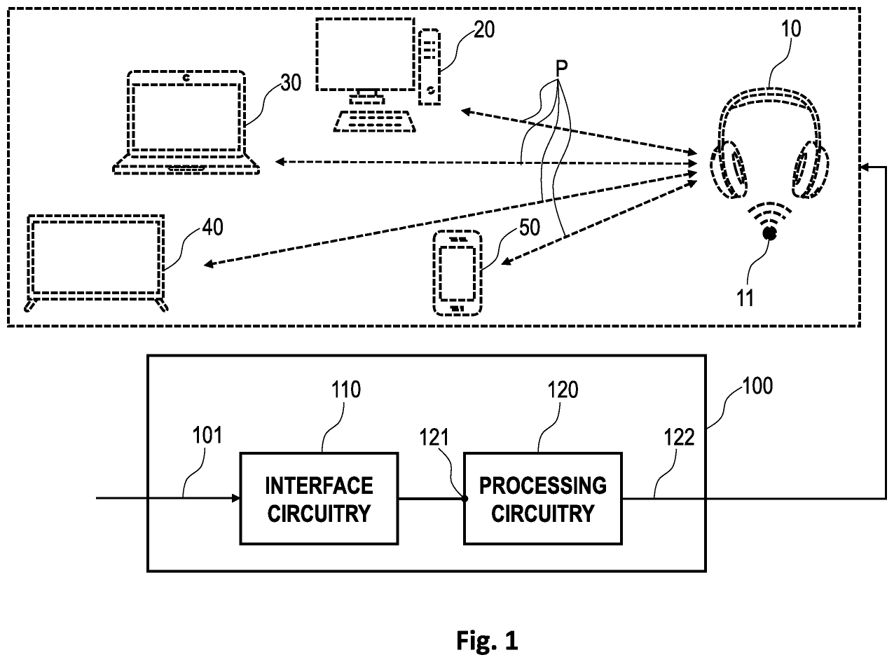

FIG. 1 schematically illustrates an exemplary apparatus 100 for controlling output of media content. The apparatus 100 described herein is illustrated in solid lines. Further, merely for a better understanding of the apparatus 100, FIG. 1 illustrates, in dashed lines, an exemplary application scenario to which the apparatus 100 may be applied. In general, the apparatus 100 is configured to control output of media content via one or more of a wearable device 10, configured for a radio connection 11 that is used to transfer at least part of the media content, and one or more playback-capable devices 20, 30, 40, 50. Thereby, during its operation, the wearable device 10 may be located at a certain location, or may be moved, e.g., carried by a moving user (not shown), to different locations, wherein in each location, the wearable device has a respective proximity P, or in other words a respective distance, to the one or more playback-capable devices 20, 30, 40, 50.

The apparatus 100 comprises interface circuitry 110 configured to receive input data 101, which at least indicate a current state of the radio connection 11 of the wearable device 10 and a respective proximity P of the wearable device 10 to the one or more playback-capable devices 20, 30, 40, 50. In FIG. 1, the respective proximity P is indicated by arrows. For example, the input data 101 may be received via a wireless connection, a wired connection, or a combination thereof. Thereby, the input data 101 may be received from a single entity or device, or from several different entities or devices, which may include one or more of the wearable device 10, at least one of the playback-capable devices 20, 30, 40, 50, a server, a cloud environment, a master device, or the like. In at least some examples, the interface circuitry 110 may also be referred to as an input node that is communicatively connected to at least one further entity or device for receiving the input signal 101 therefrom.

Further, the apparatus 100 comprises processing circuitry 120 operatively coupled to the interface circuitry 110. For example, an input node 121 of the processing circuitry 120 may be coupled to the interface circuitry 110 to receive the input data 101. The processing circuitry 120 is configured to determine one or more of the wearable device 10 and the one or more playback-capable devices 20, 30, 40, 50 for output of the media content based on the input data 101. Further, the processing circuitry 120 is configured to generate, based on the determination, output data 122 for controlling the output of the media content accordingly. As indicated in FIG. 1 by an arrow, the output data 122 may be provided, for example, to one or more of the wearable device 10 and the one or more playback-capable devices 20, 30, 40, 50.

Alternatively or additionally, the output data 122 may be provided to any other entity or device (not shown), such as the above-mentioned server, cloud environment, master device, or the like, to be controlled in connection with the output of the media content. Such other entity or device may be configured to be communicatively connected to one or more of the wearable device 10 and the one or more playback-capable devices 20, 30, 40, 50. The control data 122 may comprise information, instructions, or the like, configured to cause output of the media content via one or more of the wearable device 10 and the one or more playback-capable devices 20, 30, 40, 50. For this, the processing circuitry 120 may be communicatively coupled, e.g., via a wireless and/or wired connection, to one or more of the wearable device 10, the one or more playback-capable devices 20, 30, 40, 50 and/or the other entity or device, via an output node (not shown), a communication circuitry (not shown), a communication network (not shown), or the like. Further, at least one of the apparatus 100, the one or more playback-capable devices 20, 30, 40, 50 and the other entity or device, e.g., server, cloud environment, master device, etc., may be configured to peer-to-peer transfer at least part of the media content to the one or more playback-capable devices 20, 30, 40, 50.

Accordingly, the apparatus 100, and particularly its processing circuitry 120, is configured to control one or more of the wearable device 10 and the one or more playback-capable devices 20, 30, 40, 50 to output the media content based on at least the respective proximity P of the wearable device 10 to the one or more playback-capable devices 20, 30, 40, 50, and optionally the master device, e.g., one of the playback-capable devices 20, 30, 40, 50 or another device, considering the current state of the radio connection 11 of the wearable device 10. In at least some examples, the apparatus 100 may also be configured to cause handover of the radio connection 11 of the wearable device 10 from one device to another, e.g., from one master device to another, based on the respective proximity P to the devices and/or the current state of the radio connection 11, by providing corresponding control data to the respective devices.

The apparatus 100 may allow to determine, also dynamically, the most appropriate device for outputting the media content, and/or establishing and/or holding the radio connection 11 to the wearable device 10, even if the wearable device 10, or the user wearing or carrying it, changes its location or moves relative to the one or more playback-capable devices 20, 30, 40, 50 and/or the master device. In addition, the apparatus 100 may allow to connect the wearable device 10 to the most appropriate device, such as the most appropriate one of the playback-capable devices 20, 30, 40, 50 and/or the master device, by controlling handover of the radio connection 11 thereto.

For example, in the exemplary application scenario illustrated in FIG. 1, it may be desirable to first playback the media content on a first device, e.g., one of the playback-capable devices 20, 30, 40, 50, to which there is initially the closest proximity with the wearable device 10, and then, while or after the wearable device 10 has moved, to playback the media content on a second device, e.g., another one of the playback-capable devices 20, 30, 40, 50, to which the wearable device 10 then has the closest proximity. In the exemplary scenario according to FIG. 1, a user of the wearable device 10 may first use the playback-capable device 20, i.e., sit in front of it and participate in a video conference or the like, for example, using the above-mentioned application program that may be executed by e.g., the playback-capable device 20 or another device. Thereby, the user may at least temporarily use the wearable device 10, for example, to handle the audio data and/or voice data of the video conference via the wearable device 10 and may use the playback-capable device 20 to playback other media content, such as video content of the video conference. Then, the user may, still wearing the wearable device 10, move from the location of the playback-capable device 20 to another location, e.g., the respective location of any one of the other playback-capable devices 20, 30, 40. Alternatively, the user may switch from the playback-capable device 20 to the other playback-capable device 50, which may be a mobile phone, tablet computer, or the like, in order to move to another location therewith. The apparatus 100 described herein may allow to determine the other playback-capable device 20, 30, 40, 50 and cause output of the media content via that device, which is more appropriate for media playback due to its closer proximity to the user and/or the wearable device 10. In other words, the apparatus 10 may control playback of the media content via the respective device closest to the user's and/or the wearable device's 10 current location. Such a control of the output of the media content may also referred to as selective handover.

As used herein, the media content to be output may comprise, for example, one or more of audio content, video content, or the like. In at least some examples, the media content may be part of a call (session), a conference (session), or the like, such as a computer call, video call, tele conference, video conference, a music or video stream, etc. Accordingly, the audio content may comprise voice data, and the video content may comprise the corresponding video content of such call, conference, music or video stream, etc. Also, in at least some examples, the media content, e.g., the video content, may include an online presentation, such as e.g., a screen of another user shared online, e.g., during a video conference, or any other media content. The media content may be part of and/or generated, received, played, displayed, mirrored, etc. by an application program, e.g., a software application. It may be executed by any one of the playback-capable devices 20, 30, 40, 50. For example, the application program may be a software application for telephony, video telephony, tele or video conferencing, music or video streaming, or the like. The apparatus 100 and/or the application program may be configured to cause at least part of the media content, e.g., audio content, to be output via the wearable device 10 and to cause another part of the media content to be output via the one or more playback-capable devices 20, 30, 40, 50. Further, the apparatus 100 may be configured to access and/or control the respective application program. If the application program is executed by several of the playback-capable devices 20, 30, 40, 50, in parallel, the application program, e.g., instances of it, may be interconnected, handed over, synchronized, or the like, across the respective playback-capable devices 20, 30, 40, 50 and the wearable device 10. Further, the apparatus 100 may be configured to access and/or control the respective application program(s). Alternatively or additionally, another device, such as the server, cloud environment, master device, or the like, may be communicatively connected to the apparatus 100 and may execute the application program.

Further, as described above, the input data 101 may at least indicate the current state of the radio connection 11 and the respective proximity P of the wearable device 10 to the one or more playback-capable devices 20, 30, 40, 50 or the master device.

Thereby, the current state of the radio connection 11 may indicate, for example, whether at least part of the media content is currently output via a first one of the playback-capable devices 20, 30, 40, 50, wherein the processing circuitry 120 may be configured to determine, based on the input data 101, especially based on the current state of the radio connection 11, whether the output of at least part of the media content is to be switched to a second one of the playback-capable devices 20, 30, 40, 50. For example, the current state of the radio connection 11 to be indicated by the input data 101 may be selected from: an idle state, a media active state, a media active and moving state, a media handover state. In the idle state, the user and/or the wearable device 10 is not actively engaged in any radio connection or media content activity, such as being in a call, streaming music, or video, sharing files, or the like. In the idle state, the wearable device 10 may be paired to one or more devices, such as the playback-capable devices 20, 30, 40, 50, the master device, etc., but does not need to be connected thereto. In the media active state, the radio connection 11 is active to one device, such as one of the playback-capable devices 20, 30, 40, 50, the master device, etc., and the user and/or wearable device 10 is actively engaged in media content activity, such as being in a call, streaming music or video, sharing files, etc. In the media active and moving state, the radio connection 11 is active to one device, such as one of the playback-capable devices 20, 30, 40, 50, the master device, etc., the user and/or wearable device 10 is actively engaged in media content activity, and the user and/or wearable device 10 moves relatively to the device to which the wearable device 10 is connected. In the media handover state, the radio connection 11 is active to one device, such as one of the playback-capable devices 20, 30, 40, 50, the master device, etc., the user and/or wearable device 10 is actively engaged in media content activity, the user and/or wearable device 10 moves relatively to the device to which the wearable device 10 is connected, and the output of the media content is at least partially handed over to another device, such as another one of the playback-capable devices 20, 30, 40, 50, another master device, etc. Further, the current state of the radio connection 11 may indicate whether at least part of the media content is currently output via a first one of the playback-capable devices 20, 30, 40, 50 and/or the master device, wherein the processing circuitry 120 may be configured to determine, based on the input data 101, whether the output of at least part of the media content is to be switched or handed over to a second one of the playback-capable devices 20, 30, 40, 50 or another master device. In addition, the current state of the radio connection 11 may further indicate the wearable device 10 being radio connected to a first one of the playback-capable devices 20, 30, 40, 50 or the master device, and the processing circuitry 120 may be configured to determine the output of at least part of the media content via a second one of the playback-capable devices 20, 30, 40, 50 or another master device, if a distance of the wearable device 10 to the first one of the playback-capable devices 20, 30, 40, 50 exceeds a threshold indicating a boundary of the radio connection and/or the radio connection 11, e.g., its signal quality or strength drops below a threshold.

Further, by way of example, the respective proximity P indicated by the input data 101 may be determined based on measurement of a signal, quality a signal strength, a power present in a received radio signal, or the like. For example, the respective proximity P may be determined based on a received signal strength indicator (RSSI). This RSSI may be received, detected, etc. by the wearable device 10 and provided to the apparatus 100 as part of the input data 101. Thereby, the one or more playback-capable devices 20, 30, 40, 50 and/or the master device may periodically send an advertisement, e.g., beacons, RSSI information, or the like, which may be received, detected, etc. by the wearable device 10. Thereby, the wearable device 10 may be configured to provide, via the radio connection 10, the input data 101 at least indicating the respective proximity P. e.g., using the RSSI, to the apparatus 100. Alternatively or additionally, the one or more playback-capable devices 20, 30, 40, 50 may send corresponding information, e.g., the RSSI or the like, to the apparatus 100, e.g., via a communication network.

In at least some embodiments, the input data 101 may comprise or may also be referred to as telemetry data periodically sent by the one or more playback-capable devices 20, 30, 40, 50 to be received and forwarded or determined by e.g., the wearable device 10 and/or the apparatus 100. For example, the input data 101 or telemetry data, respectively, may comprise or indicate one or more of: a capability bit for media content offload, a current timestamp, e.g., timing information, connection interval, etc., a media status, e.g., idle, streaming, call, hold, paused, etc., a RSSI associated with a radio connection, e.g., radio connection 11 etc., a packet error statistic, e.g., errors during a call or the like, a currently connected device details, such as a device identifier, a vendor ID, etc., a measurement threshold set, e.g., provided in dBm or the like, a critical threshold set, e.g., provided in dBm or the like, for indicating a boundary of the respective radio connection, a scan duty cycle or interval, a scan type, e.g., passive or active.

Further, in at least some examples, the input data 101 may further indicate a respective capability of the one or more playback-capable devices 20, 30, 40, 50. Thereby, the processing circuitry 120 may be configured to determine, based on the respective capability, the output of at least part of the media content via at least one of the playback-capable devices 20, 30, 40, 50. For example, the capability of the one or more playback-capable devices 20, 30, 40, 50 may be indicated by information about at least one of a device type, a connection signal quality, e.g., by the respective RSSI etc., a battery status, and a type of media supported.

The wearable device 10, as used herein, may be any electronic device that can be worn or carried by a user (not shown) and that is configured to at least playback media content. It is noted that although FIG. 1 exemplarily illustrates the wearable device 10 as a headset, it may be any other device type that is configured to at least playback media content, such as a smartwatch, portable loudspeaker, or the like. The wearable device 10 may be configured for unidirectional communication and may be configured to receive media content to at least playback the respective media content. In at least some examples, the wearable device 10 may be configured for bidirectional communication and may be configured to receive and playback media content and may also be configured to capture, e.g., via a microphone etc., and transmit media content. Further, the wearable device 10 may be configured to establish, use, etc., the radio connection 11, which is used to transfer media content at least the output of which is to be controlled by the apparatus 100. For this purpose, the wearable device 10 may comprise one or more of a loudspeaker, a microphone, a display etc. for playing and/or capturing the media content, a communication circuit for establishing the radio connection 11 and/or receiving and/or transmitting the media content and/or receiving control data from the apparatus 100, a control circuit, etc. In at least some examples, the wearable device 10 may be configured to establish the radio connection 11 to another device via Bluetooth® or any other shortrange wireless technology. Thereby, the radio connection 11 may be established to at least one of the one or more playback-capable devices 20, 30, 40, 50, the above-mentioned master device, etc. In at least some examples, if there is the above-mentioned master device to which the wearable device 10 is connected via the radio connection 11, the master device may be configured to peer-to-peer transfer at least part of the media content to at least one of the playback-capable devices 20, 30, 40, 50, either via a wireless or wired connection. It is noted that the one or more playback-capable devices 20, 30, 40, 50, the master device, etc. may be in the same communication network, such as a local network. Thereby, the communication network may use a network connection or network protocol that is different to that of the radio connection 11.

Further, as used herein, the one or more playback-capable devices 20, 30, 40, 50 may be understood as any electronic device, computing device, or the like, configured to at least playback media content. For this purpose, the one or more playback-capable devices 20, 30, 40, 50 may comprise one or more of a loudspeaker, a display, a microphone, a communication circuit for receiving and/or transmitting the media content and/or receiving control data from the apparatus 100, a control circuit, etc. To illustrate that different types of devices may be used for this purpose, FIG. 1 shows four different devices or device types, wherein these may be stationary or portable. Suitable device types may include, for example, a computer, such as a desktop computer or laptop, a tablet computer, a mobile phone, a (smart) tv, a wireless speaker, e.g., Bluetooth® speaker, a video projector, or the like. It is noted that although FIG. 1 exemplarily illustrates four playback-capable devices 20, 30, 40, 50, there may be provided only one, two, three, or even more, e.g., five, six or more playback-capable devices. The one or more playback-capable devices 20, 30, 40, 50 may be configured to establish the radio connection 11 to the wearable device 10. Alternatively, however, as described above, the radio connection 11 of the wearable device 11 may be established to another device, such as the above-mentioned master device or the like. For example, such master device may be configured to peer-to-peer transfer, either via a wireless or wired connection, at least part of the media to at least one of the playback-capable devices 20, 30, 40, 50. Further, by way of example, at least one of the playback-capable devices 20, 30, 40, 50 may be configured to peer-to-peer transfer, either via a wireless or wired connection, at least part of the media to another one of the playback-capable devices 20, 30, 40, 50. Such peer-to-peer transfer may be implemented as screen mirroring, Miracast®, or any other peer-to-peer transfer technique.

Also, as used herein, the output data 122 may comprise a user prompt instruction for querying whether to output at least part of the media content via at least one of the playback-capable devices. For example, the processing circuitry 120 may be configured to cause output the user prompt via at least one of the playback-capable devices 20, 30, 40, 50 and/or the master device. Alternatively or additionally, the processing circuitry 120 may be configured to cause output the user prompt via the wearable device 10. Further, by way of example, the interface circuitry 110 may be configured to receive user input in response to the user prompt. Thereby, the processing circuitry 120 may be configured to determine, based on the user input, whether to output at least part of the media content via the at least one of the playback-capable devices 20, 30, 40, 50. For example, the user prompt may be any indicator, such as an acoustic indicator, a visual indicator, an input field, a pop-up window, or the like. The user input may be a key input, a voice command or the like, which may be input via the wearable device 10, at least one of the playback-capable devices 20, 30, 40, 50, the master device, etc.

It is noted that the apparatus 100 may be part of a system according to the exemplary application scenario according to FIG. 1. Accordingly, such system may comprise the apparatus 100, the wearable device 10, and the one or more playback-capable devices 20, 30, 40, 50. Thereby, the apparatus 100 may be coupled to the wearable device 10 and to at least one of the playback-capable devices 20, 30, 40, 50 to receive the input data 101 therefrom and to provide output data 122 thereto. Further, the apparatus 100 may be arranged in at least one of the playback-capable devices 20, 30, 40, 50. Alternatively, the apparatus 100 may be arranged in the above-mentioned master device, which may be one of the playback-capable devices 20, 30, 40, 50 or may be additionally provided to and communicatively connected to the one or more playback-capable devices 20, 30, 40, 50. Further alternatively, the apparatus 100 may be arranged in a server, cloud computing environment or the like, and communicatively connected to at least one of the playback-capable devices 20, 30, 40, 50 via e.g., a communication network. It is noted that the apparatus 100 may also be arranged in a distributed manner across the above-mentioned devices, server, cloud computing environment, etc. Accordingly, in an example including the master device, which may, for example, be any device configured to establish e.g., the radio connection 11 to the wearable device 10 and execute an application program associated with the media content to be output, the input data 101 may also comprise the respective proximity P to the master device. Alternatively, one of the playback-capable devices 20, 30, 40, 50 may form the master device.

It is noted that the processing circuitry 120 may, e.g., be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The processing circuitry 120 may optionally be operatively connected to, e.g., read only memory (ROM) for storing software such as a program, random access memory (RAM) and/or nonvolatile memory. In particular, the software or program may have a program code for causing the processing circuitry to perform the above and below described functionalities, when the software or program is executed by the processing circuitry 120.

Based on the foregoing description, the apparatus 100 may be modified in many ways.

In at least some examples, the processing circuitry 120 may be configured to compare the respective proximity of the wearable device 10 to the one or more playback-capable devices 20, 30, 40, 50, and optionally the master device, and/or the current state of the radio connection 11 to at least one corresponding threshold, and to determine, based on the comparison, via which of the wearable device 10 and the one or more playback-capable devices 20, 30, 40 50 the media content is to be output. Further, in at least some examples, the processing circuitry 120 may be configured to compute a map indicating at least one of the respective proximity of the wearable device 10 to the one or more playback-capable devices 20, 30, 40, 50, and optionally to the master device, and a respective location of the wearable device 10, and to determine, based on the map, via which of the wearable device 10 and the one or more playback-capable devices 20, 30, 40, 50 the media content is to be output.

Further, in at least some examples, the processing circuitry 120 may be configured to determine, based on the input data 101, movement of the wearable device 10 relative to the one or more playback-capable devices 20, 30, 40, 50, and/or optionally to the master device, and to determine, based on the movement and optionally the current state of the radio connection 11, the one or more of the wearable device 10 and the one or more playback-capable devices 20, 30, 40, 50 for output of the media content. In addition, the processing circuitry 120 may be configured to determine, based on the input data 101, whether the wearable device 10 is moving away from a first one of the playback-capable devices 20, 30, 40, 50, or optionally the master device, and moving in closer proximity to a second one of the playback-capable devices 20, 30, 40, 50, or optionally another master device, and to determine the output of at least part of the media content via the second one of the playback-capable devices 20, 30, 40, 50 being in closer proximity.

Further, in at least some examples, the processing circuitry 120 may be configured to determine a contextual behavior of the user of the wearable device 10. For example, the contextual behavior of the user may refer to what times the user is at a particular location, how long the user stays at a particular location, etc. For instance, it may be determined that the user is often in the kitchen at lunchtime, making coffee or food at certain times, etc. Based on the contextual behavior of the user, the processing circuitry 120 may be configured to determine the output of at least part of the media content via at least one of the playback-capable devices 20, 30, 40, 50. According to the foregoing example, the at least one of the playback-capable devices 20, 30, 40, 50 may be located in or near the particular location, such as the kitchen, etc. The contextual behavior of the user may be determined based on tracking the wearable device 10, etc.

In addition, the media transfer or a part of the media transfer may occur not just on the proximity trigger but may also be combined with constantly collecting one or more performance counters for assessment of live radio connection quality of the currently established radio link on which the media is being transferred. For example, as the wearable 10 may move away from the currently established link, these link quality performance counters may trigger a proximity radio scanning of the wearable device 10 to find a better and stronger one of the playback-capable devices 20, 30, 40, 50 for transfer. Thereby, the apparatus 100 may be configured to determine the most appropriate the playback-capable device 20, 30, 40, 50 based on the collected data, e.g., from last few seconds of sampling the field data.

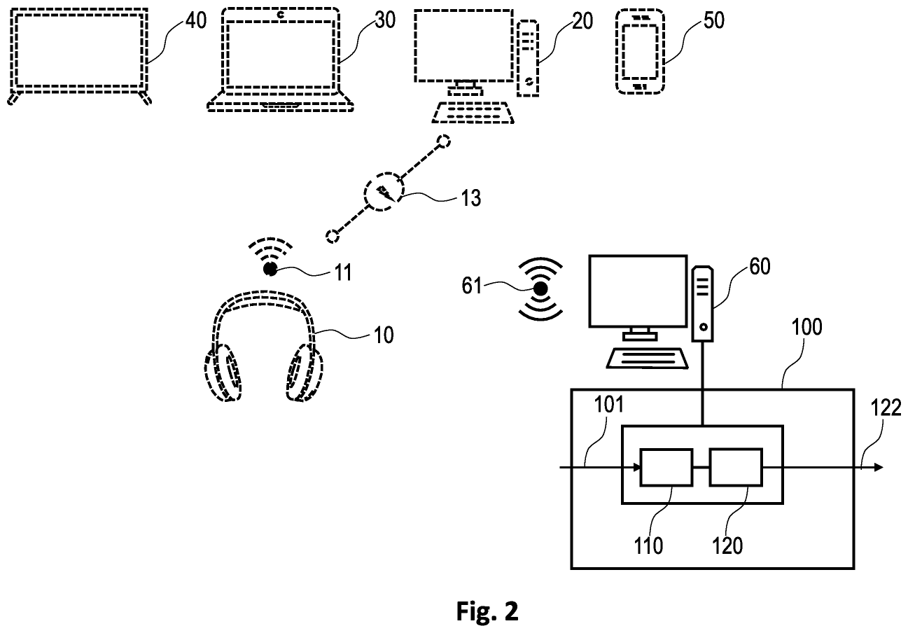

FIG. 2 illustrates another exemplary application scenario to which the apparatus 100 may be applied to. As in the foregoing exemplary application scenario, there are one or more playback-capable devices 20, 30, 40, 50, which may periodically advertise, e.g., by respectively sending beacons, sending RSSI information, etc., their capability for playback of the media content. Thereby, the advertisements of the one or more playback-capable devices 20, 30, 40, 50 may be received via the wearable device 10 and/or may be provided via a communication network, such as a local network, or the like to the apparatus 100. Further, in this exemplary application scenario, the apparatus 100 is communicatively connected to or incorporated into the above-mentioned master device, which is in FIG. 2 denoted by reference sign 60. The master device 60 is configured to transfer, e.g., broadcast, the media content to the one or more playback-capable devices 20, 30, 40, 50, via e.g., a wireless connection, a wired connection, a communication network, such as a local network, or the like, wherein such connection is indicated in FIG. 2 by reference sign 61.

As described above, the apparatus 100 is configured to receive the input data 110. Thereby, the input data 101 may at least indicate the current state of the radio connection 11 and the respective proximity P of the wearable device 10 to the one or more playback-capable devices 20, 30, 40, 50. Further, as described above, the apparatus 100, and particularly its processing circuitry 120, is configured to control one or more of the wearable device 10 and the one or more playback-capable devices 20, 30, 40, 50 to output the media content based on at least the respective proximity P of the wearable device 10 to the one or more playback-capable devices 20, 30, 40, 50, considering the current state of the radio connection 11 of the wearable device 10. In at least some examples, the apparatus 100 may also be configured to cause handover of the radio connection 11 of the wearable device 10 from the playback-capable device 20 to another of the playback-capable devices 30, 40, 50, based on the respective proximity P to the devices and/or the current state of the radio connection 11, by providing the corresponding control data 122 to the respective devices, e.g., via the connection 61.

In this exemplary application scenario, the wearable device 10 and/or the user wearing it may move from the playback-capable device 20, which may firstly playback at least part of the media content, to any one of the other playback-capable devices 30, 40, 50, wherein the apparatus 100 causes media content to be then output via another of the playback-capable devices 30, 40, 50 that is more appropriate, e.g., in closer proximity to the wearable device 10 due to its movement.

Further, in this exemplary application scenario, controlling the output of the media content may also be referred to as master orchestrated transfer. Accordingly, the master device 60 and/or the apparatus 100 may have network capabilities, i.e., may be connected to the above-mention communication network, and may be configured to control and perform the media content transfer to the playback-capable devices 20, 30, 40, 50. Thereby, the media content transfer may be carried out by peer-to-peer transfer or point-to-point transfer, by e.g., as screen mirroring, Miracast®, or any other peer-to-peer transfer technique.

It is noted that the master device 60 may also be formed by any one of the playback-capable devices 20, 30, 40, 50. Further, the apparatus 100 may be part of a system according to the exemplary application scenario according to FIG. 2. Accordingly, such system may comprise the apparatus 100, the wearable device 10, and the one or more playback-capable devices 20, 30, 40, 50. Thereby, the apparatus 100 may be coupled to the wearable device 10 and to at least one of the playback-capable devices 20, 30, 40, 50 to receive the input data 101 therefrom and to provide output data 122 thereto.

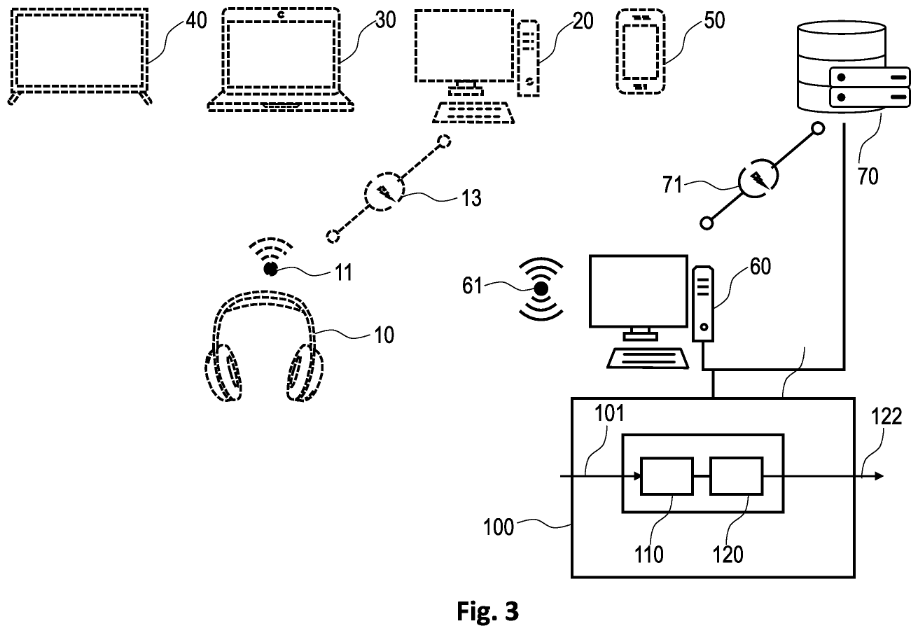

FIG. 3 illustrates another exemplary application scenario to which the apparatus 100 may be applied to. As in the foregoing exemplary application scenarios, there are one or more playback-capable devices 20, 30, 40, 50, which may periodically advertise, e.g., by respectively sending beacons, sending RSSI information, etc., their capability for playback of the media content. Thereby, the advertisements of the one or more playback-capable devices 20, 30, 40, 50 may be received via the wearable device 10 and/or may be provided via a communication network, such as a local network, or the like to the apparatus 100. Further, as in the exemplary application scenario according to FIG. 2, there is the master device 60 that is configured to transfer, e.g., broadcast, the media content to the one or more playback-capable devices 20, 30, 40, 50, via the connection 61. In addition to the foregoing exemplary application scenario according to FIG. 2, the master device 60 is communicatively connected to another entity or device 70, which may be a server, cloud environment or the like, as mentioned above. The connection between the master device 60 and the entity or device 70 is indicated in FIG. 3 by reference sign 71, and may be established via a communication network or the like. The entity or device 70 may be configured to manage, store, etc., at least part of the input data 101. The apparatus 100 may be connected to or may be at least in part incorporated into the entity or device 70, i.e., the server, cloud environment, etc.

Further, in this exemplary application scenario, only the master device 60 may have network capabilities, e.g., the connection 71 to the entity or device 70, while the one or more playback-capable devices 20, 30, 40, 50 do not have such network capability but are merely connectable to the master device 60 as described above with reference to FIG. 2. Again, as in the foregoing example, controlling the output of the media content may also be referred to as master orchestrated transfer. Accordingly, the master device 60 may be configured to control and perform the media content transfer to the playback-capable devices 20, 30, 40, 50. Thereby, the media content transfer may be carried out by peer-to-peer transfer or point-to-point transfer, by e.g., as screen mirroring, Miracast®, or any other peer-to-peer transfer technique.

Again, in this exemplary application scenario, the wearable device 10 and/or the user wearing it may move from the playback-capable device 20, which may firstly playback at least part of the media content, to any one of the other playback-capable devices 30, 40, 50, wherein the apparatus 100 causes media content to be then output via another of the playback-capable devices 30, 40, 50 that is more appropriate, e.g., in closer proximity to the wearable device due to its movement. Here, the master device 60 may be configured to receive information, e.g., included in the output data 122, about the most appropriate of the playback-capable devices 20, 30, 40, 50 from the apparatus 100, and to control the output of the media content based on this information.

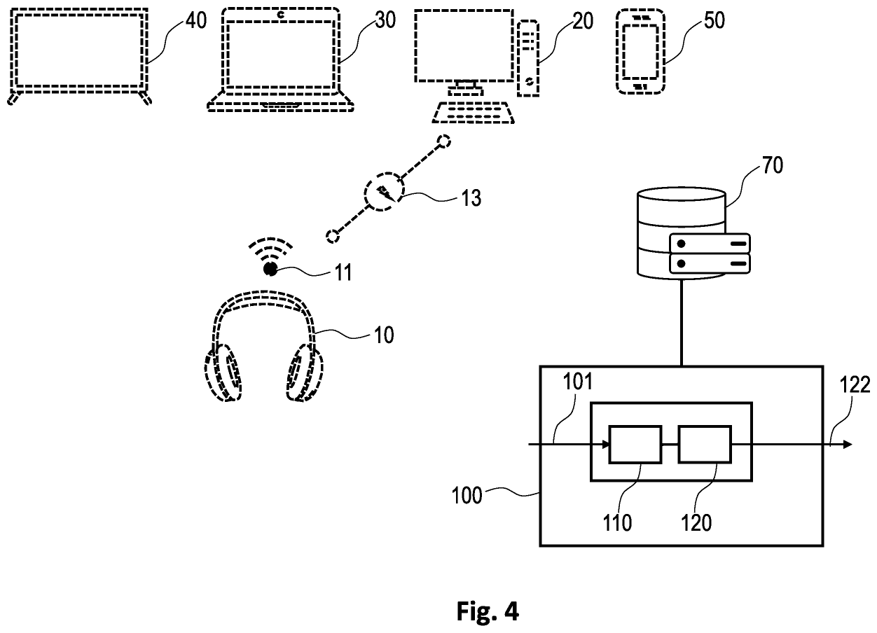

FIG. 4 illustrates another exemplary application scenario to which the apparatus 100 may be applied to. As in the foregoing exemplary application scenarios, there are one or more playback-capable devices 20, 30, 40, 50, which may periodically advertise, e.g., by respectively sending beacons, sending RSSI information, etc., their capability for playback of the media content. Thereby, the advertisements of the one or more playback-capable devices 20, 30, 40, 50 may be received via the wearable device 10 and/or may be provided via a communication network, such as a local network, or the like to the apparatus 100. Here, however, the master device 60 is omitted and the apparatus 100 is connected or implemented at least in part into the into the above-mentioned entity or device 70, i.e., the server, cloud environment, etc.

In this exemplary application scenario, the one or more playback-capable devices 20, 30, 40, 50 have network capability, e.g., may be connected to communication network. Here, controlling the output of the media content may also be referred to as server or cloud orchestrated media content transfer. Compared to the exemplary application scenarios according to FIG. 2 and FIG. 3, the topology of FIG. 4 is master less. Further, the input data 101 may be provided to apparatus 100 and/or the entity or device 70 via the communication network. Then, the apparatus 100 may provide the control data 122 to the one or more playback-capable devices 20, 30, 40, 50 via the communication network. It is noted that the output data 122 may also be provided to the wearable device 10. This application scenario may allow scalability of the apparatus 100 and/or the corresponding system to which it belongs.

Again, in this exemplary application scenario, the wearable device 10 and/or the user wearing it may move from the playback-capable device 20, which may firstly playback at least part of the media content, to any one of the other playback-capable devices 30, 40, 50, wherein the apparatus 100 causes media content to be then output via another of the playback-capable devices 30, 40, 50 that is more appropriate, e.g., in closer proximity to the wearable device due to its movement. Here, at least the most appropriate of the one or more playback-capable devices 20, 30, 40, 50 may receive the output data 122 from the apparatus and/or the entity or device 70, and to control the output of the media content accordingly.

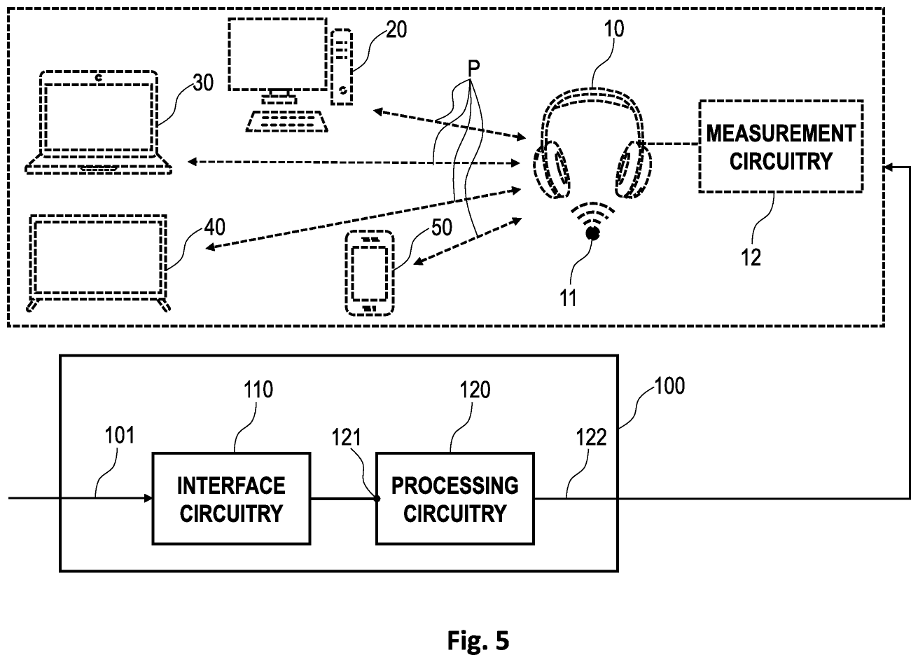

FIG. 5 illustrates another exemplary application scenario to which the apparatus 100 may be applied to. As in the foregoing exemplary application scenarios, there are one or more playback-capable devices 20, 30, 40, 50, which may periodically advertise, e.g., by respectively sending beacons, sending RSSI information, etc., their capability for playback of the media content. Thereby, the advertisements of the one or more playback-capable devices 20, 30, 40, 50 may be received via the wearable device 10.

For this purpose, the wearable device 10 may comprise measurement circuitry 12 configured to receive and/or measure the advertisement provided by the one or more playback-capable devices 20, 30, 40, 50. It is noted again that the other playback-capable devices 20, 30, 40, 50 periodically advertise their proximity and/or capability for playback of media content to the wearable device 10, and particularly its measurement circuitry 12. The wearable device 10 may also be configured to determine the respective proximity P to the one or more playback-capable devices 20, 30, 40, 50. The respective proximity P may then be included in the input data 101.

As described above, the apparatus 100 is configured to receive the input data 110 from the wearable device 10, e.g., its measurement circuitry 12, either directly or e.g., via one of the playback-capable devices 20, 30, 40, 50 to which the wearable device 10 may be connected. Thereby, the input data 101 may at least indicate the current state of the radio connection 11 and the respective proximity P of the wearable device 10 to the one or more playback-capable devices 20, 30, 40, 50, wherein at least the latter may be determined by the measurement circuitry 12 of the wearable device 10 based on the advertisements of the one or more playback-capable devices 20, 30, 40, 50.

Again, in this exemplary application scenario, the wearable device 10 and/or the user wearing it may move from the playback-capable device 20, which may firstly playback at least part of the media content, to any one of the other playback-capable devices 30, 40, 50, wherein the apparatus 100 causes media content to be then output via another of the playback-capable devices 30, 40, 50 that is more appropriate, e.g., in closer proximity to the wearable device due to its movement. Here, at least the most appropriate of the one or more playback-capable devices 20, 30, 40, 50 may receive the output data 122 from the apparatus and/or the entity or device 70, and to control the output of the media content accordingly.

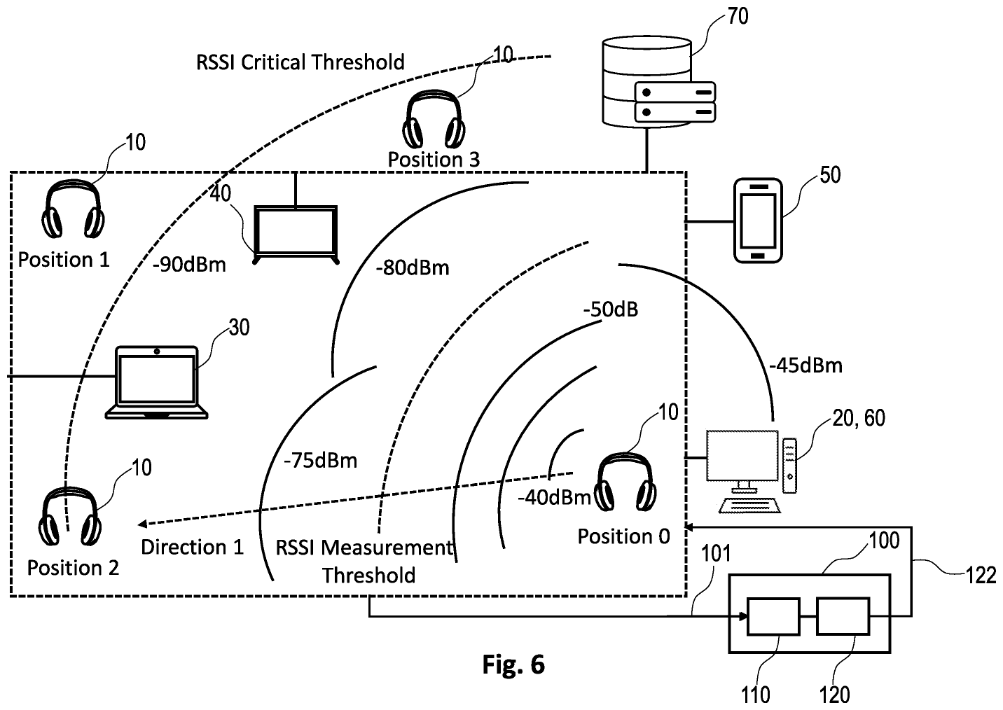

With reference to FIG. 6, which shows another exemplary application scenario to which the apparatus 100 may be applied to, the apparatus 100 will be further explained. In particular, FIG. 6 illustrates a walkthrough of the flow of information while the wearable device 10 is moving, which movement is indicated in FIG. 6 by Position 0, Position 1 and Position 2.

As in some of the foregoing exemplary application scenarios, there may be the optional master device 60 and the optional entity or device 70, i.e., the server, cloud environment or the like.

It is noted that one or more of the following pre-conditions may be given. For example, the wearable device 10 may be paired with the one or more playback-capable devices 20, 30, 40, 50, e.g., by a low energy radio connection or the like, which may keep running a low duty cycle scan for listening and reconnection. By way of example, such low energy radio connection may be in an idle state and/or low power mode. If provided, the wearable device 10 may be included in a whitelist to allow a radio connection with the respective device. Once radio connected via a radio connection, e.g., via the radio connection 11 (see e.g., FIGS. 1 to 5), the playback-capable devices 20, 30, 40, 50 may keep monitoring the RSSI of the poll replies from the wearable device 10, e.g., by using the GATT Link or the like. If not connected, the playback-capable devices 20, 30, 40, 50 may keep scanning for the advertisements and optionally reconnect to the wearable device 10 whenever possible. Further, the apparatus 100 may set an RSSI Critical Threshold and/or a Measurement Threshold for the wearable device 10, wherein FIG. 6 illustrates those thresholds by dashed lines. It is noted that those thresholds may correspond to the at least one threshold described herein. A measurement unit of those thresholds may be dBm.

Further, it is noted that each of the optional master device 60, the optional entity or device 70, the apparatus 100 and the one or more playback-capable devices 20, 30, 40, 50 may be communicatively connected to at least some of the others, which is indicated in FIG. 6 by line connection to a dashed rectangle, which may indicate a corresponding backend, communication network, local network, or the like.

Sill referring to FIG. 6, it may be started with the wearable device 10 being in Position 0. It may be communicatively connected via the radio connection to the master device 60. It is noted that, as described above, the wearable device 10 may alternatively be connected to one of the playback-capable devices 20, 30, 40, 50 instead. The radio connection may be used to transfer media content, e.g., audio content, to the wearable device 10. The audio content may relate to video content, both of which may belong to a call, conference or the like, as described above. At Position 0, the wearable device 10 may be in proximity to the master device 60, which may be the corresponding RSSI expressed in the unit dBm and which may have a value of e.g., −40 dBm. The apparatus 100 may control the video content to be output via the master device 60, e.g., via a display thereof. For example, the wearable device 10 may be configured to monitor the RSSI and may provide this information to the apparatus 100 and/or the entity or device 70.

Then, the wearable device 10 may be moved, e.g., carried by its user, along Direction 1, which is indicated in FIG. 6 by an arrow in dashed lines. That is, the wearable device 10 moves away from the master device 60 towards Position 2, which is at the boundary set by the RRSI Critical Threshold indicated in FIG. 6 by a dashed line. In this example, the RRSI Critical Threshold has a value around −90 dBm, e.g., >−65 dBm and <−90 dBm. The wearable device 10 may be configured to monitor the corresponding RSSI of the radio connection to the master device 1 and once beyond the RRSI Critical Threshold, it may be configured to start a timer and periodically monitor strength and other parameters, e.g., every 1 s. If the RSSI goes beyond the RRSI Critical Threshold in this duration, the wearable device 10 may start background scanning and look out for the other playback-capable devices 20, 30, 40, 50 around, here, for example, playback-capable device 30 and/or playback-capable device 40. Presence of the playback-capable devices 20, 30, 40, 50 may be determined based on their respective advertisement sent. The wearable device 10 may be configured to measure the RSSI of each of the playback-capable devices 20, 30, 40, 50 in radio range and provide that information to the apparatus 100, e.g., via the GATT channel. Alternatively, the information may be provided from the wearable device 10 to the master device 60. The information may be included in the input data 101 described herein. As described above, the apparatus 100 may be configured to control the media content to be output via the most appropriate of the playback-capable devices 20, 30, 40, 50 based on the corresponding input data 101. In addition, the apparatus 100 may be configured to switch the radio connection of the wearable device 10 with the master device 60 to the most appropriate playback-capable devices 20, 30, 40, 50.

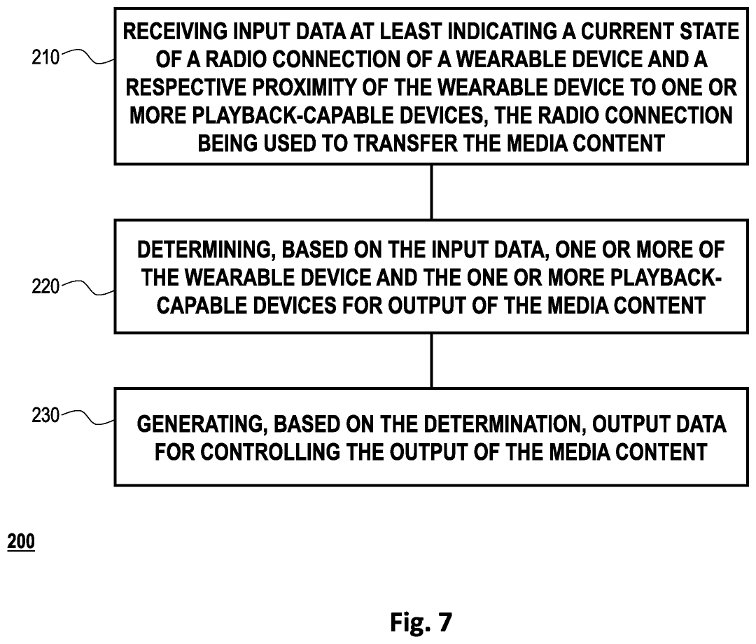

For further illustrating the analog-to-digital conversion described above, FIG. 7 illustrates in a flowchart a method 200 for controlling output of media content. The method comprises receiving 210 input data at least indicating a current state of a radio connection of a wearable device and a respective proximity of the wearable device to one or more playback-capable devices, the radio connection being used to transfer the media content. The method further comprises determining 220, based on the input data, one or more of the wearable device and the one or more playback-capable devices for output of the media content. Further, the method comprises generating 230, based on the determination, output data for controlling the output of the media content.

The method 200 may allow to determine, also dynamically, the most appropriate device for outputting the media content, and/or establishing and/or holding the radio connection to the wearable device, even if the wearable device, or the user wearing or carrying it, changes its location or moves relative to the one or more playback-capable devices and/or the master device. In addition, the method may allow to connect the wearable device to the most appropriate device, such as the most appropriate one of the playback-capable devices and/or the master device, by controlling handover of the radio connection thereto.

More details and aspects of the method 200 are explained in connection with the proposed technique or one or more examples described above (e.g., FIGS. 1 to 6). The method 200 may comprise one or more additional optional features corresponding to one or more aspects of the proposed technique or one or more examples described above.

For example, the method 200 may further comprise dynamically determining the one or more of the wearable device and the one or more playback-capable devices for output of the media content based on the respective proximity of the wearable device to the one or more playback-capable devices.

The examples described herein may be summarized as follows:

An example (e.g., example 1) relates to an apparatus for controlling output of media content. The apparatus comprises interface circuitry configured to receive input data at least indicating a current state of a radio connection of a wearable device and a respective proximity of the wearable device to one or more playback-capable devices, the radio connection being used to transfer the media content; and processing circuitry configured to determine, based on the input data, one or more of the wearable device and the one or more playback-capable devices for output of the media content, and to generate, based on the determination, output data for controlling the output of the media content.

Another example (e.g., example 2) relates to a previous example (e.g., example 1) or to any other example, wherein the processing circuitry is configured to dynamically determine the one or more of the wearable device and the one or more playback-capable devices for output of the media content based on the respective proximity of the wearable device to the one or more playback-capable devices.

Another example (e.g., example 3) relates to a previous example (e.g., example 2) or to any other example, wherein the processing circuitry is configured to compare the respective proximity of the wearable device to the one or more playback-capable devices and/or the current state of the radio connection to at least one corresponding threshold, and to determine, based on the comparison, via which of the wearable device and the one or more playback-capable devices the media content is to be output.

Another example (e.g., example 4) relates to a previous example (e.g., example 3) or to any other example, wherein the processing circuitry is configured to compute a map indicating at least one of the respective proximity of the wearable device to the one or more playback-capable devices and a respective location of the wearable device, and to determine, based on the map, via which of the wearable device and the one or more playback-capable devices the media content is to be output.

Another example (e.g., example 5) relates to a previous example (e.g., example 4) or to any other example, wherein the current state of the radio connection indicates whether at least part of the media content is currently output via a first one of the playback-capable devices, wherein the processing circuitry is configured to determine, based on the input data, whether the output of at least part of the media content is to be switched to a second one of the playback-capable devices.

Another example (e.g., example 6) relates to a previous example (e.g., example 5) or to any other example, wherein the processing circuitry is configured to determine, based on the input data, movement of the wearable device relative to the one or more playback-capable devices, and to determine, based on the movement, and optionally the current state of the radio connection, the one or more of the wearable device and the one or more playback-capable devices for output of the media content.

Another example (e.g., example 7) relates to a previous example (e.g., example 6) or to any other example, wherein the processing circuitry is configured to determine, based on the input data, whether the wearable device is moving away from a first one of the playback-capable devices and moving in closer proximity to a second one of the playback-capable devices, and to determine the output of at least part of the media content via the second one of the playback-capable devices being in closer proximity.

Another example (e.g., example 8) relates to a previous example (e.g., example 7) or to any other example, wherein the current state of the radio connection further indicates the wearable device being radio connected to a first one of the playback-capable devices, and the processing circuitry is configured to determine the output of at least part of the media content via a second one of the playback-capable devices if a distance of the wearable device to the first one of the playback-capable devices exceeds a threshold indicating a boundary of the radio connection, and optionally the radio connection drops below a corresponding threshold.

Another example (e.g., example 9) relates to a previous example (e.g., example 8) or to any other example, wherein the processing circuitry is configured to determine output of a first part of the media content via the wearable device and output of a second part of the media content via at least one of the playback-capable devices.

Another example (e.g., example 10) relates to a previous example (e.g., example 9) or to any other example, wherein the media content comprises audio content and video content, and the processing circuitry is configured to determine output of at least one of the audio content and the video content via the at least one of the playback-capable devices and/or the wearable device.

Another example (e.g., example 11) relates to a previous example (e.g., example 10) or to any other example, wherein the processing circuitry is configured to determine output of the audio content via the wearable device and output of the video content via at least one of the playback-capable devices.

Another example (e.g., example 12) relates to a previous example (e.g., example 11) or to any other example, wherein the input data further indicates a respective capability of the one or more playback-capable devices, and the processing circuitry is configured to determine, based on the respective capability, the output of at least part of the media content via at least one of the playback-capable devices.

Another example (e.g., example 13) relates to a previous example (e.g., example 12) or to any other example, wherein the capability of the one or more playback-capable devices is indicated by information about at least one of a device type, a connection signal quality, a battery status, and a type of media supported.

Another example (e.g., example 14) relates to a previous example (e.g., example 13) or to any other example, wherein the processing circuitry is configured to determine a contextual behavior of a user of the wearable device and to determine, based on the contextual behavior of the user, the output of at least part of the media content via at least one of the playback-capable devices.

Another example (e.g., example 15) relates to a previous example (e.g., example 14) or to any other example, wherein the output data comprises a user prompt instruction for querying whether to output at least part of the media content via at least one of the playback-capable devices.

Another example (e.g., example 16) relates to a previous example (e.g., example 15) or to any other example, wherein the interface circuitry is configured to receive user input in response to the user prompt, and the processing circuitry is configured to determine, based on the user input, whether to output at least part of the media content via the at least one of the playback-capable devices.

Another example (e.g., example 17) relates to a previous example (e.g., example 16) or to any other example, wherein the processing circuitry is configured to cause output of the user prompt via at least one of the playback-capable devices.

Another example (e.g., example 18) relates to a previous example (e.g., example 17) or to any other example, wherein the processing circuitry is configured to cause output of the user prompt via the wearable device.

Another example (e.g., example 19) relates to a system, comprising an apparatus for controlling output of media content according to a previous example (e.g., any one of examples 1 to 17), a wearable device configured to establish a radio connection; and one or more playback-capable devices capable of outputting at least part of the media content, wherein the apparatus is coupled to the wearable device and to at least one of the playback-capable devices to receive input data therefrom and to provide output data thereto.

Another example (e.g., example 20) relates to a previous example (e.g., example 19) or to any other example, wherein the wearable device is configured to collect information of a respective proximity of the wearable device to the one or more playback-capable devices and to provide this information as input data to the apparatus.

Another example (e.g., example 21) relates to a previous example (e.g., example 20) or to any other example, wherein the wearable device is configured for establishing the radio connection to at least one of the playback-capable devices to provide, via the radio connection, input data at least indicating a respective proximity of the wearable device to the one or more playback-capable devices to the apparatus.

Another example (e.g., example 22) relates to a previous example (e.g., example 21) or to any other example, wherein at least one of the playback-capable devices is coupled to a communication network, and the at least one of the playback-capable devices is configured to provide, via the communication network, input data at least indicating a respective proximity of the wearable device to the at least one of the playback-capable devices to the apparatus.

Another example (e.g., example 23) relates to a previous example (e.g., example 22) or to any other example, wherein the apparatus is arranged in at least one of the playback-capable devices.

Another example (e.g., example 24) relates to a previous example (e.g., example 23) or to any other example, wherein the apparatus is arranged in a cloud computing environment and coupled to at least one of the playback-capable devices via a communication network.

Another example (e.g., example 25) relates to a previous example (e.g., example 24) or to any other example, wherein at least one of the playback-capable devices is configured to peer-to-peer transfer at least part of the media to another one of the playback-capable devices.

Another example (e.g., example 26) relates to a previous example (e.g., example 25) or to any other example, wherein the wearable device is a headset.

Another example (e.g., example 27) relates to a previous example (e.g., example 26) or to any other example, wherein the wearable device is configured to establish the radio connection via Bluetooth.

Another example (e.g., example 28) relates to a method for controlling for controlling output of media content, comprising receiving input data at least indicating a current state of a radio connection of a wearable device and a respective proximity of the wearable device to one or more playback-capable devices, the radio connection being used to transfer the media content; determining, based on the input data, one or more of the wearable device and the one or more playback-capable devices for output of the media content; and generating, based on the determination, output data for controlling the output of the media content.

Another example (e.g., example 29) relates to a previous example (e.g., example 28) or to any other example, further comprising dynamically determining the one or more of the wearable device and the one or more playback-capable devices for output of the media content based on the respective proximity of the wearable device to the one or more playback-capable devices.

Another example (e.g., example 30) relates to a non-transitory machine-readable medium having stored thereon a program having a program code for performing the method according to a previous example (e.g., example 28 or 29), when the program is executed on a processor or a programmable hardware.

Another example (e.g., example 31) relates to a program having a program code for performing the method according to claim 28 or 29, when the program is executed on a processor or a programmable hardware.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), ASICs, integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for controlling output of media content, the apparatus comprising:
interface circuitry configured to receive input data at least indicating a current state of a radio connection of a wearable device and a respective proximity of the wearable device to one or more playback-capable devices, the radio connection being used to transfer the media content; and
processing circuitry configured to:
determine, based on the input data, one or more of the wearable device and the one or more playback-capable devices for output of the media content; and
generate, based on the determination, output data for controlling the output of the media content.

2. The apparatus of claim 1, wherein the processing circuitry is configured to dynamically determine the one or more of the wearable device and the one or more playback-capable devices for output of the media content based on the respective proximity of the wearable device to the one or more playback-capable devices.

3. The apparatus of claim 1, wherein the processing circuitry is configured to compare the respective proximity of the wearable device to the one or more playback-capable devices to at least one corresponding threshold, and to determine, based on the comparison, via which of the wearable device and the one or more playback-capable devices the media content is to be output.

4. The apparatus of claim 1, wherein the processing circuitry is configured to compute a map indicating at least one of the respective proximity of the wearable device to the one or more playback-capable devices and a respective location of the wearable device, and to determine, based on the map, via which of the wearable device and the one or more playback-capable devices the media content is to be output.

5. The apparatus of claim 1, wherein the current state of the radio connection indicates whether at least part of the media content is currently output via a first one of the playback-capable devices, wherein the processing circuitry is configured to determine, based on the input data, whether the output of at least part of the media content is to be switched to a second one of the playback-capable devices.

6. The apparatus of claim 1, wherein the processing circuitry is configured to determine, based on the input data, movement of the wearable device relative to the one or more playback-capable devices, and to determine, based on the movement, the one or more of the wearable device and the one or more playback-capable devices for output of the media content.

7. The apparatus of claim 1, wherein the processing circuitry is configured to determine, based on the input data, whether the wearable device is moving away from a first one of the playback-capable devices and moving in closer proximity to a second one of the playback-capable devices, and to determine the output of at least part of the media content via the second one of the playback-capable devices being in closer proximity.

8. The apparatus of claim 1, wherein the current state of the radio connection further indicates the wearable device being radio connected to a first one of the playback-capable devices, and the processing circuitry is configured to determine the output of at least part of the media content via a second one of the playback-capable devices if a distance of the wearable device to the first one of the playback-capable devices exceeds a threshold indicating a boundary of the radio connection.

9. The apparatus of claim 1, wherein the processing circuitry is configured to determine output of a first part of the media content via the wearable device and output of a second part of the media content via at least one of the playback-capable devices.

10. The apparatus of claim 1, wherein the media content comprises audio content and video content, and the processing circuitry is configured to determine output of at least one of the audio content and the video content via the at least one of the playback-capable devices and/or the wearable device.

11. The apparatus of claim 1, wherein the input data further indicates a respective capability of the one or more playback-capable devices, and the processing circuitry is configured to determine, based on the respective capability, the output of at least part of the media content via at least one of the playback-capable devices.

12. The apparatus of claim 11, wherein the capability of the one or more playback-capable devices is indicated by information about at least one of a device type, a connection signal quality, a battery status, and a type of media supported.

13. The apparatus of claim 1, wherein the processing circuitry is configured to determine a contextual behavior of a user of the wearable device and to determine, based on the contextual behavior of the user, the output of at least part of the media content via at least one of the playback-capable devices.

14. The apparatus of claim 1, wherein the output data comprises a user prompt instruction for querying whether to output at least part of the media content via at least one of the playback-capable devices.

15. The apparatus of claim 14, wherein the interface circuitry is configured to receive user input in response to the user prompt, and the processing circuitry is configured to determine, based on the user input, whether to output at least part of the media content via the at least one of the playback-capable devices.

16. A system, comprising:
an apparatus for controlling output of media content according to claim 1;
a wearable device configured to establish a radio connection; and
one or more playback-capable devices capable of outputting at least part of the media content;
wherein the apparatus is coupled to the wearable device and to at least one of the playback-capable devices to receive input data therefrom and to provide output data thereto.

17. The system of claim 16, wherein the wearable device is configured to collect information of a respective proximity of the wearable device to the one or more playback-capable devices and to provide this information as input data to the apparatus.

18. The system of claim 16, wherein the wearable device is configured for establishing the radio connection to at least one of the playback-capable devices to provide, via the radio connection, input data at least indicating a respective proximity of the wearable device to the one or more playback-capable devices to the apparatus.

19. The system of claim 16, wherein at least one of the playback-capable devices is coupled to a communication network, and the at least one of the playback-capable devices is configured to provide, via the communication network, input data at least indicating a respective proximity of the wearable device to the at least one of the playback-capable devices to the apparatus.

20. The system of claim 16, wherein the apparatus is arranged in a cloud computing environment and coupled to at least one of the playback-capable devices via a communication network.

21. The system of claim 16, wherein at least one of the playback-capable devices is configured to peer-to-peer transfer at least part of the media to another one of the playback-capable devices.

22. The system of claim 16, wherein the wearable device is a headset.

23. The system of claim 16, wherein the wearable device is configured to establish the radio connection via Bluetooth.

24. A method for controlling output of media content, comprising:
receiving input data at least indicating a current state of a radio connection of a wearable device and a respective proximity of the wearable device to one or more playback-capable devices, the radio connection being used to transfer the media content;
determining, based on the input data, one or more of the wearable device and the one or more playback-capable devices for output of the media content; and
generating, based on the determination, output data for controlling the output of the media content.

25. The method of claim 24, further comprising dynamically determining the one or more of the wearable device and the one or more playback-capable devices for output of the media content based on the respective proximity of the wearable device to the one or more playback-capable devices.
